(19) United States
(12) Patent Application Publication
(10) Pub. No.: US 2024/0008496 A1
(43) Pub. Date: Jan. 11, 2024

(54) METHOD AND APPARATUS FOR PROVIDING RUN TIME RESERVOIR IN DOUGH PORTIONING SYSTEM DURING DOUGH FEEDER REFILL CYCLE

(71) Applicants: Vinicius Franca Uchoas, Vancouver (CA); Norman Schmidt, Burnaby (CA)

(72) Inventors: Vinicius Franca Uchoas, Vancouver (CA); Norman Schmidt, Burnaby (CA)

(73) Assignee: Food Machinery Engineering LTD., Surrey, BC (CA)

(21) Appl. No.: 18/220,816

(22) Filed: Jul. 11, 2023

Related U.S. Application Data
(60) Provisional application No. 63/388,243, filed on Jul. 11, 2022.

(51) Int. Cl. A21C 1/14; A21C 5/00; B65G 47/18

(52) U.S. Cl. CPC A21C 1/145; A21C 5/00; A21C 1/144; A21C 1/148; B65G 47/18; B65G 2201/04

(57) ABSTRACT

A novel method and apparatus of controlling dough feeding to process and portioning machines in automated processing lines is provided. The completed system can supply dough and dough like materials to a portioner and or allow it to continue its operation during a period of time when the one or more feeding machine needs to go to a mixer to obtain another load of bulk material, a refill cycle, and returns to a home station so as to resume feeding operations of dough. The desired effect is to have a feeding system that can both store dough to continue dough supply to one or more portioning machine(s) while the feeding machine(s) can go to a mixer to obtain a new batch of bulk dough and again return to home position where it can feed dough to one or more conveyor system(s) to maintain feed of dough to portioning machine(s) without an interruption due to stoppages in feed arising from the need for the feeder to go to a mixer and receive additional dough from the mixer and then return to the feeding conveyors. Additionally the controller allows for a variety of settings regarding the dough level and the portioner to prevent air entrapment.

### CROSS-REFERENCE TO RELATED APPLICATIONS

This application claims the priority of U.S. provisional patent application 60/388,243, filed Jul. 7, 2022, which is incorporated herein by reference.

### FIELD OF THE INVENTION

A novel method and apparatus of controlling material feeding to process and portioning machines in automated large scale commercial applications, such as but not limited to bakeries, is provided. Reference herein is made to dough as a non-limiting example of a dough like or semi-solid material. The instant invention can work equally well with other food materials, such as but not limited to meats, or non-food materials, such as plastics and the like. The novel device uses machinery sub-components in conjunction with new additions of technology so that the completed system can supply dough materials during a period of time when one or more feeding machine need to go to a mixer to obtain additional loads of bulk dough or other materials and returns to a home station so as to resume feeding operations of dough or other materials. The desired effect is to have a feeding system that can both store dough so as to continue dough supply to one or more portioning machine(s) while the feeding machine(s) can go to a mixer to obtain a new batch of bulk dough and again return to home position where it can feed dough to one or more conveyor system(s) to maintain feed of dough to portioning machine(s) without an interruption due to stoppages in the feed arising from the need for the feeder to go to a mixer and receive additional dough from the mixer and then return to the feeding conveyors.

### BACKGROUND OF THE INVENTION

In the production of baked goods and/or meat products, such as but not limited to English muffins, the dough is mixed and discharged into a feeding machine that will take the large bulk batch of mixed dough and feed it to a portioning machine or machines that require the dough to be fed in a reasonable, uniform and consistent manner. Again, reference herein is made to dough but is an example of semi-solid materials, dough being used in a representative capacity. Other examples of semi-solid materials can include for instance but are not limited to food stuffs, like meat in sausage products for example, or non-food products, such as plastics in for example extrusion processing and portioning. Returning to the description of the exemplary embodiment for dough and baking, problems can occur due to the dough mixing, which is a cyclic process that occurs in conjunction with the portioning process, where the mixed batch is delivered on a periodic basis to the feeder for feeding to the portioning device. During the discharge of the dough from mixer to the dough feeder it is often the case that the dough feeder must be stopped and/or travels from a docking station to a dough receiving point typically in front of the mixer where dough is then discharged from mixer to the feeder to resupply the feeder.

This interruption in feeding and the time taken by the dough feeder to obtain and return from the dough mixer to the transfer conveyor docking station, e.g. the dough feeder refill cycle, can cause a portioning machine to use up the dough that it has in the receiving hopper. When the dough in the hopper is all used up, the portioning machine will have to be stopped, reset, and restarted. This process wastes critical production time and during this down time production is lost.

There are also ever present safety concerns with such large mechanical systems as those used in commercial dough mixing. Design elements appear in the subsystems that address the safety concerns but that further complicate and predicate the need for improved transfer processing. There are typically guards over the top of the dough feeder which needs to be in place to provide for operator safety during operation. As when the dough feeder is operating there are a lot of large moving pieces that can cause injury or worse to an employee. Therefore, when dough needs to be transferred from the mixer to the feeder the time where the guards are off or removed at the feeder or in an open position, the dough feeder will stop, and this will result in “starving” the feed to the portioner. This can result in an issue whereby the portioner has to be reset, as noted herein.

The dough will typically be transferred from the mixer to the dough feeder. A few minor ingredients will be transferred into the mixer and the mixing process for the next batch begun or if there is a switch in the material, cleaning can begin. And then the guards on the feeder are put back in place. In some cases the dough feeder is also very complex due to design requirements where large rotating parts must be significantly guarded. In this situation to receive dough into the dough feeder typically guards must be moved out of place so as to allow for receiving of dough then the guards need to be put back in place before returning to the feeding of dough or to permit travel of feeder to a docking station before feeding of dough can resume. The dough feeder needs to move to the dough discharge docking position or station and will again feed dough to the portioning machine once the safeguards at the feeding station are engaged. These safeguards, although absolutely necessary, can add to the down time of the machines and to the complexity of the dough feeder refill cycle.

Other examples of feeder operation, besides the static feeder hopper scenario noted above, can include but are not limited instances where the dough feeding can be made to not be always operating in front of the mixer where it could be placed in a non-static operating position and a filling position. This can include for instance separate moveable tubs, typically used for instance in meat processing, to move the meat to the feeder from a storage area. Similarly, in dough machines a shifting or non-static dough feeder position is provided in some instances such that the feeder having a feeder hopper table can be moved to a fill position. In dough handling the feeder hopper table can be moved away from in front of the mixer for purposes such as but not limited to cleaning and or removing different types of dough when making a change from one dough type to another such as but not limited to changing from white to whole wheat flour for example.

Such a filling operation allows for a means to shift the feeder hopper table in front of the dough mixer and permit easier access to the mixing machine to remove stuck or excess dough that does not easily come out. Similar systems are utilized having smaller bins in various types of manufacturing, such that processed or chunked materials from a mixer or treatment machine must be transported to the feeder hopper for a portioning apparatus. In each system, safeguards remain in place to maintain safety, for instance to prevent falling into a vat or to maintain cleanliness or other manufacturing variables. In each instance, the safety features and the movement provide for a potential stoppage in operation for the portioning of the dough or semi-solid material.

At other times the feeding machines are designed to move away from the mixer face so as to provide an operator with a means to add minor ingredients to the mixer bowl without having to reach and twist to get these ingredients into the bowl of the mixer where operator stresses and strains can occur. Other reasons to have the dough feeder move across the face and/or away from the face of the mixer, as noted, is to provide a means for an operator to remove residual dough from the mixer bowl and associated mix bar surfaces and into the dough feeder without the need to climb over the side of the dough feeder whereby the operator would possibly need to re-engage guards to protect from falling into said dough feeder.

Another item that can be provide as needed to move the dough feeder from the front of the dough mixer would be that an operator needing to add minor ingredients to the mixer bowl could need to reach in, around, or over the feeder hopper whereby some of these minor ingredient could spill making the product or dough contacted by minor ingredients produce differing products from what was intended.

A moving dough feeder or feeder hopper would also aid in allowing operators to clean out the mixer bowl so as to remove residual dough that can be of a type or kind that contained allergens such as but not limited to seeds, milk extracts, or other such allergens. In this case the feeder is made to be a mobile machine that moves to the mixer to get dough then go back out of the way and away from the front of the mixer. Regardless, the issue remains with this design of dough feeder that it can only feed dough when it is at a “home” position where the dough feeder can discharge the dough into the conveyor system that takes the dough from the feeder to the portioning machine. This docking position is away from the mixer.

This added time of travel of the dough feeder can present issues in that it increases the time required to stop feeding through and together with the added time to get the new dough mix and return to the dough discharge feeding home position location where it can once again feed dough. There are also typically conveyors involved that can transport the dough from the feeder docking location to the portioning machinery. Regardless of the feeder type and operating characteristics, the feeder will need to be fed more dough and/or be refilled. This currently requires a stoppage in portioning and potentially an operating hazard in running the portioner to “starved” condition, as explained herein below.

One can think that to overcome this problem, one could make a larger hopper on the portioning machine so as to give sufficient storage of dough required by the portioning machine so as to remain running would be good or suffice but it has some significant detriments. Such as but not limited to the added dough will contact and adhere to the wall of the hopper and require a scrape down of the sides of the hopper to ensure that dough does not stagnate on the walls which makes it ferment and if at a time where the reserve capacity or reserve dough is used then this older dough can go into the system and produce product that is not the same as other produced product and/or be noticeably different in appearance and or texture, taste, etc. As well as the issues with cleanliness that occur from the deposited material that adheres to the hopper if it is simply enlarged.

The solution would best incorporate a reservoir in between the dough feeder dissimilar to the container like size and shape of the existing hopper to avoid additional adhering material as described above. This would be located between the feeder and the portioner, so as to accumulate dough during the operational time and issue it out in the time when the feeder hopper has to travel to the mixer and back as well as the time that it takes to get the dough out of the mixer and into the feeder. The ideal situation or process is where dough gets mixed and is fed into the portioning machine hopper in a way that it can go thru in such a way as first dough in will be the first dough out and dough content is minimized for continuous thru flow with minimum points that are stagnant and minimizing adhered material. The reserve amount of dough would amount to that which can be used while the dough feeder is traveling from the dough discharging docking station, to the mixer, then travelling back to the dough discharge docking station and re-starting the feed dough to the line comprised of conveyors that will take the dough from the dough feeder to the dough portioning machine. This requires well designed hopper of a specifically designed size and/or a method where the dough always feeds in succession.

It is further envisioned by the inventor that one way to do this is to have a smaller dough hopper on the portioning machine so that dough always flows thru it and is not likely to stick to the sides of the hopper where it can age and/or become old and ferment with the results being previously noted and undesirable. To do this the device would need to use an enlarged dough conveyor to act as a reservoir, a reservoir conveyor, which would always have or contain dough on it that can be fed on a steady or small portion feed process so that the hopper level of the portioning machine stays at a lower level but sufficient to provide adequate dough level to the hopper so as to not allow starvation of dough supply in the portioning machine and/or the draw in of air into the portioning machine during the dough feeder refill cycle.

The resulting device and reservoir conveyor would need to communicate with a controller which measures and monitors aspects of the sub-component systems in the dough supply and portioning system. The controller would communicate with a variety of sensors which sense a variety of variables related to the portioning machine, the portioning hopper, the reservoir conveyor, the feeder subsystem, the feeder supply hopper, and other elements of the system.

Such a device would not only reduce down time and lost production, but also ensure greater quality of product and reduce waste. When making products such as but not limited to English muffins and or bread rolls the baking process is rather critical as compared to when one makes products such as “plain” breads. If for instance when making English muffins, the bake time or the temperature rises, then the product profile of inner soft texture and outside color can be adversely affected. If one were to stop the oven, for instance during a period of time where air entrainment has occurred in a portioning machine, so as to wait for additional product and pans to enter the oven then the bake time would effectively be increased and product would get burned from delays.

Additionally, once the baking recipe of temperature and time are created the oven will typically always run at that recipe and the product will remain consistent during a product run. In a steady state condition, where the supply of portioned product is consistent, the amount of heat input is proportional to the heat needed for the product to bake to the required finished product plus the heat required to heat the pan. Problems arise when amount of heat that is required decreases because the amount of product that goes into the oven changes, e.g. the portioning, is inconsistent and/or there stoppage in the supply of product. Thus a need exists for uniform portioning and consistent operation to ensure uniform product and production, avoid wasted time and man hours, and reduce waste and improve product quality.

When a stoppage is necessary in the portioner, for instance when the portioning machine hopper reaches a level just before the portioning machine would draw air in and at that point stops. The ability to stop ahead of the entrainment of air also provides for an intermediate pause between the portioning machine and the downstream line. This allows for just a short continuation of the next machine which is where the dough portions go onto, for instance a belt driven rounding table. Then that device would stop so that the last one to four portions which could be suspect of weight variations can be removed versus having several more portioned groups deposited onto the rounding machine. Thus, the device would also provide the ability to reduce waste on the line.

By comparison the prior art sequence entails, machine runs low on dough, entrains air, and stopping the portioning machine, chasing after underweight portions, and half of those under weight portions wind up going on the floor and in the trash and a few go back in the portioning machine hopper. By preventing issues in the portioning weights and avoiding longer delays, the instant invention avoids waste from burnt product and the waste associated in the prior art with the entrapment of air in a portioning run and how it propagates down the industrial line from the portioning machine. Thus the invention further eliminates added shutdown complexities, lost time, and restarts issues and as a byproduct improves product quality, reduces costs, and reduces waste.

### SUMMARY OF THE INVENTION

An aspect of the invention is to provide a reserve amount of dough that can be used while the dough feeder is traveling from the said dough discharging docking station, to the mixer, then travelling back to the dough discharge docking station and re-starting dough feed to the line.

A further aspect of the invention is to provide a control system as a component of a dough mixing and metering system which provides sensor inputs for variables that can include, but are certainly not limited to weight of dough in reserve, weight of dough on conveyor, time to refill cycle, safety condition sensors on the feeder, safety conditions sensors on the mixer, the indexed state of the reservoir conveyor, temperature, humidity, and the like.

Yet another aspect of the invention is a control system that can index a reservoir conveyor used to maintain flow into a hopper for a dough portioning device, sense the amount of dough remaining on or in the reservoir conveyor, register when a dough refill cycle commences, register when a dough refill cycle completes, register the new dough from the refill cycle and supply same to the reservoir conveyor at an increased rate to refill the reservoir while indexing the conveyor and returning to normal operation and additional steps necessary to provide a continuous flow of dough to the dough portioner even during the dough feeder refill cycle.

A still further aspect of the invention is that it accommodates existing operations and safeguards by registering the feeder refill cycle and providing for necessary time to operate the safety elements and procedures in the feeder refill cycle while accommodating the filling needs of the portioner machine while the dough feeder is being refilled.

An aspect of the invention is that it provides the ability to sense, in the case where there is an issue with the refill of the dough to the feeder in the refill cycle, the controller in the instant invention can signal the dough portioner machine to halt operation before any air is taken in which would require recalibration of the machine.

The invention includes a system and a method of operating the system. The invention includes a dough portioning machine with a feeding device in a commercial baking system including a portioner, a dough feeder machine providing dough to the portioner, a controller, a hopper coupled to the portioning machine and receiving dough from the dough feeder machine and a hopper demand or level sensor that determines the level of the dough in the hopper of the feeder machine. Where the dough portioner machine utilizes dough from the portioning machine hopper. As the level of dough decreases or below a low setting relative to a start value, the controller senses through the hopper demand or level sensor the low setting and the feeder is activated to provide dough to increase the level of dough in the portioning machine hopper, when and until the dough level reaches a stop or upper target level in the hopper whereby the dough feeder machine stops.

The dough feeder has a refill cycle, by which the feeder machine moves during the refill cycle to receive additional dough from a mixer and returns to a feeding position. The dough portioning machine further comprises an at least one dough reservoir conveyor adapted to hold a quantity of dough in excess of what is consumed by the portioner during the refill cycle. The dough portioning machine can further include an at least one conveyor feeding the hopper. The at least one conveyor includes an at least one vertical conveyor conveying dough to an at least one dough reservoir conveyor, the reservoir conveyor having a dough reserve thereon. The at least one vertical conveyor conveying dough to an at least one dough reservoir conveyor which is coupled to the hopper with an amount of dough on the at least one dough reservoir conveyor representing a reserve of dough.

The dough portioning machine further comprising a dough discharge docking station for the at least one feeder, wherein the refill cycle further includes the interval of time for the feeder to decouple from the docking station travel from the dough discharge docking station to the mixer, receive dough from the mixer, then return the dough feeder to the dough discharge docking station where it indexes into a feeding position. An at least one safety mechanism on the at least one feeder on the dough discharge docking station, wherein the refill cycle further includes the time to release and reestablish the at least one safety mechanism and securing.

The dough portioning machine further includes additional sensors coupled to the controller, wherein the controller is adapted to use the one or more additional sensors to calculate timing sequences initiated to replenish the dough reserve on the at least one dough reserve conveyor after a refill cycle. The controller can vary the speed of the at least one dough reservoir conveyor. The controller can be adapted to receive commands through the HMI to provide for programmable adjustments to the system. The controller can also be adapted to operate the portioner, the feeder machine providing dough to the portioner, the hopper and the at least one dough reservoir conveyor, such that the feeder discharges dough onto the at least one vertical conveyor and then upon the at least one reservoir conveyor at the slower feed speed till such a time that the reserve capacity dough on the reserve conveyor is used in part or entirely up where there would be a sizable open or void area on the reserve conveyor, which is sensed in that the feed is running but the dough level in the hopper would not be rising or being replenished at which point the controller presumes that there is a void on the reserve conveyor which was caused by refill cycle.

The dough controller can be further adapted to sense the void to operate the at least one reservoir conveyor at higher speed so as to supply dough to the portioning machine hopper and cause it to rise toward the stop level and refill the at least one dough reservoir conveyor. The dough portioning machine can include a sequencing subsystem, wherein the sequencing subsystem communicates with the controller and is configured such that it governs the volume of the dough remaining on the reservoir conveyor so that it can be calculated and communicated with the controller and the dough is more rapidly conveyed to portioning machine by going into a higher speed of operation when the feeder machine reconnects to the docking station. When the at least one vertical conveyor and the at least one dough reservoir conveyor are running at the higher speed and have deposited sufficient dough on the reservoir conveyor and brought sufficient dough to the portioning machine hopper so that the high target level is sensed the supply of dough is reduced or shut off.

The method of the invention includes operating a dough portioning machine including supplying a feeder with dough; conveying the dough from the feeder to a hopper attached to a portioner, with an at least one conveyor, with a volume of dough held as a reserve on the conveyor; depositing dough into the hopper and sensing a level in the hopper with an at least one sensor; operating the dough portioning machine such that the feeder is moved to refill with dough during a refill cycle while continuing to supply the hopper from the reserve of dough on the at least one conveyor, wherein the amount of dough in reserve on the at least one conveyor is calculated by a controller. The method can further include operating an at least one vertical conveying dough to an at least one reservoir conveyor which maintains the reserve of dough thereon. The method of operating the dough portioning machine can further include operating the at least one vertical conveying and conveying dough to a reservoir conveyor further comprises controlling with the controller the speeds of the at least one vertical conveyor and the at least one reservoir conveyor such that the reserve of dough is maintained.

The method of controlling of the speeds of the at least one vertical conveyor and the at least one reservoir conveyor further comprises running the at least one reservoir conveyor at a lower speed than the at least one vertical conveyor filling the at least one reservoir conveyor so as to raise a material per unit length of dough on the reservoir conveyor. The method of controlling of the speeds of the at least one vertical conveyor and the at least one reservoir conveyor further comprises controlling the speed of the at least one vertical conveyor relative to the at least one reservoir conveyor such that the reservoir conveyor accumulates a volume of dough for the reserve while the volume of dough in the hopper is less than a high limit as sensed by the at least one sensor.

Moreover, the above aspects and advantages of the invention are illustrative, and not exhaustive, of those which can be achieved by the invention. This summary is a high-level overview of various aspects of the invention and introduces some of the concepts that are further described in the detailed description section below. This summary is not intended to identify key or essential features of the claimed subject matter, nor is it intended to be used in isolation to determine the scope of the claimed subject matter. Thus, these and other aspects and advantages of the invention will be apparent from the description herein, both as embodied herein and as modified in view of any variations which will be apparent to those skilled in the art.

### BRIEF DESCRIPTION OF THE FIGURES

Exemplary embodiments of the invention are explained in greater detail by way of the drawings, where the same reference numerals refer to the same features.

FIG. 1 shows an embodiment of the instant invention.

FIG. 2 shows an embodiment of the instant invention with the dough feeder and feeder hopper shifted away from the portioner to a position to receive a new load of dough from the mixer.

FIG. 3 shows a view of the controller of the exemplary embodiment and its communications paths.

### DETAILED DESCRIPTION OF AN EXEMPLARY EMBODIMENT OF THE INVENTION

Exemplary embodiments according to the present invention will now be described with reference to the accompanying drawings. Although an exemplary embodiment is shown and described, it is only an example of the instant invention and is non-limiting in its description.

A method and apparatus of controlling dough feeding to process and portioning machines in automated large scale bakeries is provided. The novel device uses machinery sub-components in conjunction with a modified and novel controller so that the completed system can supply dough materials during a period of time when the one or more feeding machine needs to go to a mixer to obtain another load of bulk dough and return to a home station so as to resume feeding operations of dough, herein referred to as the dough refill cycle.

As noted above, there exists a need to provide for the instant invention to remediate issues that arise from stoppages in production caused by a forced pause during the refill cycle. This pause is needed to ensure that the portioning system is not run dry of material. This is a significant issue in commercial baking. As an example, when a portioning machine runs out of dough then it will starve or run below its minimum dough level where there is the possibility of drawing in air to the portioning machine and when air becomes entrained into the system then portions will go light in weight and have to be retrieved/removed so that underweight or too small/light product portions do not go out for sale. So an operator has to remain vigilant and watch both dough level as well as product size where underweight portion will have to be removed before the high speed/production of portions will carry the portions beyond where an operator can reach them. There is this same issue with the re-start of a portioner where the first portions must be removed until the air is purged from the portioning machine, which is determined by when full, consistent weight portions are made and portions of correct and consistent weight can go down the production line. This is typically a bit of a frantic start up procedure as portioning machines 90 can portion from one to eight portions out of one to eight portion extruding ports in a row running at up to one-hundred cuts per minute. So that at every cut, trying to remove the first portions is hectic and then must also be weighed to remove the initial portions and to confirm correct weights so as to allow the portions to go onto the line. If portions are not removed at the portioner then there is no way of retrieval and underweight portions can enter the production line and underweight products can be baked off and go out to consumers.

Regarding the description below of the instant invention, there are various forms or controllers as standalone controllers or as components in the sub-systems available to be modified and incorporate the instant invention. This description focuses on three specific controller items in generic terms and descriptions so as to provide a broad description of the apparatus and how the system operates so as to produce the desired effect of providing a reservoir system for dough as well as an operating system for reducing the time and efficiency losses arising from inadvertent starting and stopping of lines in existing systems and how to reduce these issues with portioning machine inclusion of air and the resulting inconsistency of portioned dough piece portion sizes and or deviations in portion mass. By no means is the controller limited to a single controller, it specifically can be distributed between controllers in the system or provided on more than one controller and/or to provide redundancies in the system. Nor is any operation limited in a specific means or by a specific order.

The system is typically used in operation to produce portioned product materials which can include but are not limited to the portioning of bakery products such as but not constrained to producing English muffins, bread rolls, hamburger rolls, hot dog rolls and other similar food or edible dough products it is operated via an operating system. It should also be understood that the operating system could be used in portioning of meat products but not limited to sausages meat patties and other portioned meat products or other food or non-food materials.

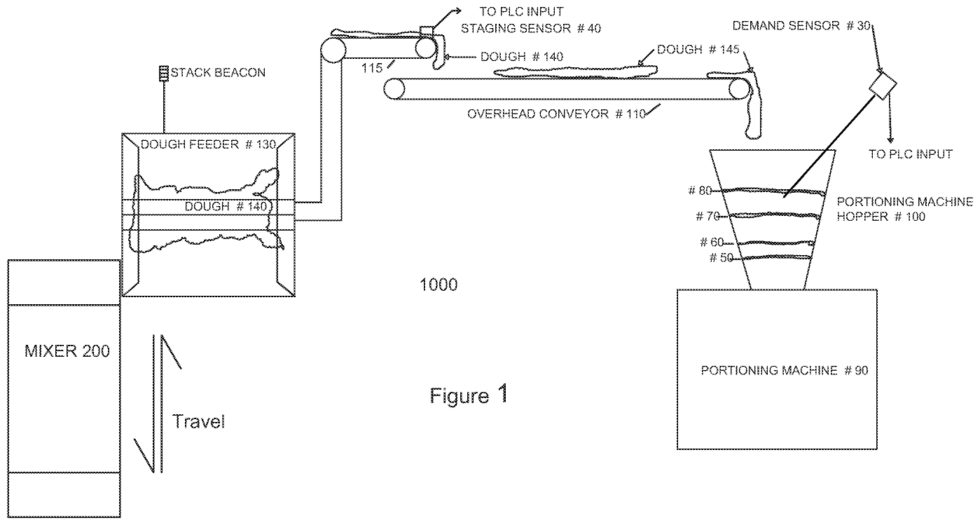

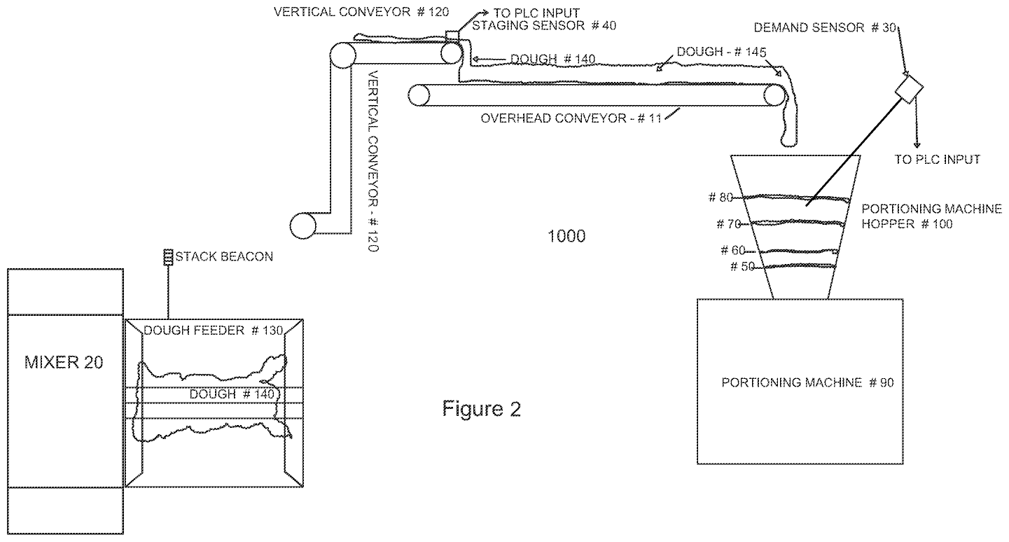

As seen in FIGS. 1 and 2, the system includes mixer 200, dough feeder 130, vertical conveyors 120, reservoir or staging conveyor 110 with staging or reservoir sensor 40, portioning machine 90, portioning machine hopper 100, portion machine hopper demand or level sensor 30, and additional components for processing mixed dough through the feeder machine 130 to the portioning machine 90 to be portioned in uniform material portions as output. Additional components can be added, additional distance between the elements provided, additional conveyor capacity provided, and additional sensors incorporated within the invention without departing from the spirit of the invention. These additional components and modifications can include for example, separating the feeder and mixer, providing motorized feeder hopper(s), additional safety restraints/covers and components to afford protection to users, additional sensors as noted herein for measuring additional variables, and the like. Additionally shown in the figure are a variety of level targets or limits in the portioning machine hopper 100 sensed by the demand or level sensor 30 as well as visual indicators, like the stack beacon, used to indicate status alerts to the user. Additionally, a controller on a PLC 20 is incorporated in one or more of the machines, as noted herein below, and communicates with the sensors to enable the instant invention to provide the correct dough reserve 145 for the system during the dough refill cycle as explained herein throughout. The details of the controller and PLC 20 are described in greater detail in FIG. 2 herein below.

When started, after any precursor startup functions and operations settings and/or setups are completed, the dough feeder 130 receives a signal from the hopper dough level sensor 30 which will provide a signal to the PLC 20 and HMI 10 as to the height of the dough 140 in the portioning machine hopper 100. The height signal and indicators derived from the signal from the hopper level dough demand sensor 30 are monitored and displayed thru the PLC 20 and Human Machine Interface (HMI) 10. The dough 140 in the hopper establishes its level through the hopper dough level sensor 30.

When the level of the dough 140 in the portioning machine hopper 100 is at a level where replenishment is required during normal operation and is confirmed to be required, then the dough feeder 130 will activate the conveyors and advance the dough 140 as shown to fill the hopper 100. Dough 140 will be fed from the dough feeder 130 to the feed conveyor 110 to the portioning machine dough hopper 100 so as to increase the dough 140 level in the portioning machine dough hopper 100 during normal operations. This includes dough in the dough reserve 145 on the reservoir conveyor 110 as noted herein. The dough reserve 145 is thereby continuously refreshed during operation. Once the dough level 140 is above the normal or low fill target 70 then it will be made possible either thru interlock or by visual inspection that the portioning machine 90 can be started so as to produce the required size/mass of dough 140 portions.

FIG. 2 shows an exemplary embodiment of the refill process of the exemplary embodiment of FIG. 1. During the course of the operation of the feeder machine 130 and the portioner machine 90, the supply of dough 140 to the feeder machine 130 will need to be replenished. This will be indicated by a sensor (not shown) in the dough feeder machine 130. Upon receipt of the signal from the dough feeder 130 a dough refill cycle is initiated in the dough feeder 130. The feed mechanism of the dough feeder 130 operation is suspended and the dough mixer 200 is engaged by the feeder machine 130. The dough mixer 200 can be engaged directly if the devices are coupled but typically a smaller feeder hopper which is motorized is released by the dough feeder 130. In the exemplary embodiment shown dough feeder hopper (not shown) is moved or shifted so that it engages with the mixer 200. Necessary safety elements are engaged, as discussed previously, and dough 140 is released from the mixer 200 into the dough feeder hopper or directly into the dough feeder 130. The time taken to release the safety elements, the engagement of the dough feeder 130 with the mixer 200, and the resupply of the dough 140 in the dough feeder 130 in a manner sufficient to feed the dough 140 to the portioner 90 is the dough refill cycle.

In operation, the reservoir 145, be it conveyor or alternative reservoir device, provides adequate amounts of dough 140 in or on the reservoir 145, here again shown as the non-limiting example of a reservoir dough conveyor 110, for the continued operation of the portion machine 90 through the duration of the period of the refill cycle plus a period of additional time, a non-limiting example being for about two or three minutes of additional time just to be sure that if a delay is encountered that the overhead storage capacity of the conveyors is sufficient to cover this needed dough 140 amount. This time can be entered into the PLC 20 using the HMI 30 to set a time for the dough refill cycle.

In the instant invention, the system uses a reservoir dough conveyor 110 between the dough feeder 130 and the portioning machine 90 to ensure non-interrupted supply of dough 140 to the portioner 90 during the dough fill cycle. The reservoir dough conveyor 110 is not limited to a conveyor; equivalent means can be designed as, for example, but certainly not limited to a slide, a vibratory chute, or similar mechanical diversion/supplementation system.

It is envisioned by the inventor that in the exemplary embodiment one way to do this is to have a relatively small dough hopper 100 on the portioning machine 90 so that dough always flows thru it and is not likely to stick to the sides of the hopper 100 where it can age and/or become old and ferment with the results being previously noted and undesirable. To do this the device would need to use an enlarged dough conveyor to act as a reservoir, a reservoir conveyor 110, which would always have or contain dough on it that can be fed on a steady or small portion feed process so that the hopper level of the portioning machine 90 stays at a lower level but sufficient to provide adequate dough material to the hopper or portioning machine so as to not allow starvation of dough supply in the portioning machine 90 and/or draw in air into the portioning machine 90 during the dough refill cycle whereby dough 140 from the mixer 200 is obtained by the feeder 130 and fed to the portioning machine 90.

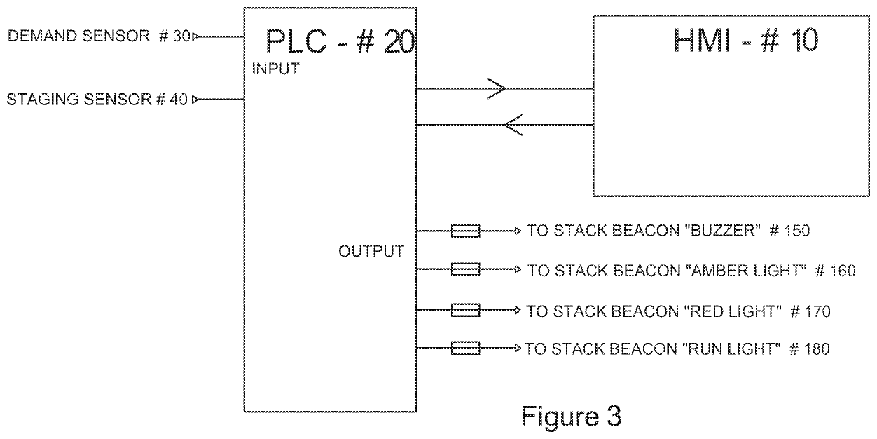

The exemplary embodiment depicted utilizes a reservoir conveyor 110 specifically designed so that it would be wide or of sufficient width and/or length to provide capacity to hold a quantity of dough 140 in excess of what is needed to be on hand and supply the dough portioning machine(s) 130 should be 90 during a dough feeder refill cycle described herein. The content or amount of dough 140 would be in excess of what is needed for the maximum reasonable amount of time to refill the hopper 100, as measured by one or more sensors, herein shown in a non-limiting example as the dough level sensor 30 and staging sensor 40, as shown in the several machine subsystems in FIG. 3, so as to carry out a continuous feed of dough 140 during the time interval of travel of the dough feeder 130 from the dough discharge docking station (not shown) to the mixer 200, receiving dough 140 from the mixer 200, then returning the dough feeder 130 to the dough discharge docking station (not shown) where it indexes into the correct position and then resumes dough feed to the various conveyors shown.

Upon return of the dough feeder 130 to the dough discharge docking station and when reserve capacity dough 145 on the conveyors 110 is used up then the feeder 130 would restart and issue out dough 140 to the overhead conveyor 110 and when the area on the conveyor 110 where dough 140 is absent due to consumption of the dough 140 with no replenishment of the dough 140 while the feeder 130 was away from the dough discharge docking station then the dough feeder 130 starts to feed dough 140 to the feed conveyor(s), here vertical conveyors 120 and the overhead horizontal or reservoir conveyors 110, and the feed conveyor(s) go to a maximum delivery speed. The reservoir conveyor 110 would allow for the calculation, for instance but certainly not limited to the weight of material on the conveyor or distance and volume calculations or similar means, enabled by at least one sensor, in the exemplary embodiment the staging sensor 140, where the conveyor 110 can be monitored and provide for the reserve 145 to maintain operation during the refill cycle. The conveyors index into the correct positions upon completion of the cycle to resupply the reserve 145 it must contain and simultaneously feed dough to the portioner hopper. As noted below, the PLC 20 controller monitors and advances the reservoir conveyor 110 to accommodate these operational states. Initially, the reservoir conveyor 110 is emptied to resupply the portioner hopper.

Once emptied, the conveyors are then operated at full speed to the upper target amount is achieved in the portioner hopper 100 and then a return to normal operation is established. As noted below, a differential in operating speeds between the conveyors during normal operation slowly increases the reserve dough 145 by amount on the conveyor on the reservoir conveyor as part of the indexing as a non-limiting example of how such indexing can occur. Other indexing means and schema can be utilized in conjunction with PLC 20, using for example but certainly not limited to sensors, conveyors, and the like to increase the reserve 145 back to needed levels on the reservoir conveyor 110.

The reading from the portioning machine hopper level sensor 30 is evaluated in the PLC 20 and if the dough 140 is going up or filling and is below the high level demand 80 then the dough feeder 130 will continue to feed dough 140 to the portioning machine hopper 100 until the dough 140 level will be at or above the full stop level 80, this value being set in the HMI/PLC 20 for example, at which point the HMI 10 will indicate the status and in conjunction with the PLC 20 will stop the dough feeder 130 as well as the vertical conveyor 120 and the staging conveyor 115 and overhead or reservoir dough conveyor 110. When the level of dough 140 in the hopper 100 of portioning machine 90 changes again, e.g. during normal operation after operating at an opening high velocity as explained herein, the staging conveyor 115 signals a lower speed for the reservoir dough conveyor 110 to fill the hopper 90 and accumulates a reserve 145 on the overhead horizontal or reservoir dough conveyor 110.

As noted, the dough feeder 130 obtains additional dough from the mixer 200 during the refill cycle. Upon return from the mixer 200 of the dough feeder 130 to the dough discharge docking station (not shown) and when reserve capacity dough 145 on the conveyors is used up during normal operations, the feeder 130 would start and issue out dough 140 added to the reservoir dough conveyor 110. When the area on the reservoir conveyor 110 where reservoir or reserve dough 145 is absent due to consumption of the dough with no replenishment of the reserve or reservoir dough 145 while the feeder 130 was away from the dough discharge docking station then the dough feeder starts to feed dough 140 to the reservoir conveyor and other feed conveyor(s) at a maximum delivery speed to complete replenishment. This operation and the control of the reservoir dough conveyor 110 and the reserve dough 145 retained thereon are described further herein below.

Upon return to normal operating mode, the dough portioner machine 90 will utilize dough 140 in the portioning machine hopper 100 and the level of dough 140 will decrease. When the level of dough 140 decreases to or below the low start filling demand level 70 is sensed then the dough feeder 130 will be activated to provide dough 140 to increase the level of dough 140 in the portioning machine hopper 100. The point where the dough level increases to the full stop level 80 whereby the dough feeder 130 will stop. As noted above, in the instance where the dough 140 in the dough feeder 130 is expended, the instant invention provides for a measured, known reserve of dough 145 to be utilized during the dough refill operation. This dough reserve 145 is sensed, monitored, indexed and calculated to cover the period of time of normal operation so as not to interrupt normal operation of the portioning machine 90.

In the event that the portioning machine 90 is running and dough 140 is not being introduced to the portioning machine hopper 100 then the level of dough 140 will start or continue to go down and it can go down to reach or go below the alarm low level 60 where the portioning machine demand sensor 30 detects or provides a signal to the PLC 20 and or the HMI 10 which will cause or enable a low level alarm buzzer 150 and light 160 to come on to alert operators of a low level condition to provide a signal that dough 140 level is decreasing below an acceptable level but portioner 90 is still running. At this point the operator can or the controller can stop the portioning machine 90 and wait for replenishment dough 140. Alternatively, if the product level is low due to a product change over, all dough 140 is being purposefully run out as far and as much as possible and then machines are cleaned out so as to be able to start to run the next dough 140 batch. If it is the case where a changeover is to be carried out then a silence/override button (not shown as may not be desired by customer and or may just be an option and is not a part of the novelty of this invention) can be activated whereby the alarm is deactivated and the machine will continue to run out of dough 140 as much as possible to lessen the work needed to clean out the portioning machine 90.

In the unlikely event that it is not a point whereby the dough 140 needs to be cleared out purposefully, the emergency shutoff option will protect the portioner 90. This could occur for instance, but is not be limited to, an instance where a feed issue has occurred or where an operator has taken too long to obtain dough 140 from the mixer 200 and therefore the system is approaching a dangerously low level of dough 140 in the hopper, a condition which the reservoir conveyor 110 and the PLC 20 are designed to avoid. Regardless, if this dough level reaches and or goes below the stop operation level 50 then the portioning machine 130 would stop operation. This stop set point is typically set so as to stop the portioning machine 90 before the dough 140 in the portioning machine hopper 100 were to go so low that air is drawn into the portioning machine 90 which creates the issue where portions being created with air in the portioning machine 90 as discussed herein throughout.

FIG. 3 shows a plan view of a controller of exemplary embodiment of the invention shown in FIG. 1. The reservoir conveyor 110 and components of the dough feeding and portion system communicate with a controller PLC 20 which measures and monitors aspects of the sub-component systems in the dough supply and portioning system 1000. The controller PLC 20 communicates with a variety of sensors which sense a variety of variables related to the portioning machine, the portioning hopper, the reservoir conveyor 110, the feeder subsystem, the feeder supply hopper, and other elements of the system. These variables can include, but are not limited to, the amount of product on reservoir conveyor 110, the weight of the product on the conveyor, the calculated volume of product, indexing value of the reservoir conveyor 110, the level in the hopper, presence of feeder bucket, time on feeder bucket, emergency stop, auto stop if calculated amount in hopper drops below a set level and the like which allow for the instant invention to monitor the dough feeder refill cycle and the reserve dough 145 contained in or on the reservoir, in this case the reservoir conveyor 110 to provide uninterrupted operation of the portioner 90.

As noted above, a sequencing system is provided as part of the PLC controller 20, so that the PLC 20 controller can increase the speed of the conveyor so that the dough 140 can rapidly get conveyed to the portioning machine 90 and the reserve replenished by operating in higher then lower speed modes when the feeder reconnects to the docking station on the feeder machine 130 based on the indexing of the system. An additional sensor (not shown) senses when the feeder hopper has returned to a specific position with the feeder 130 and indexing can begin. Such that, when the feed system runs at high speed has once again brought sufficient dough to the portioning machine hopper 100 so that it is satisfied or has reached the upper operating limit height 70, it returns to normal drop operation based on the indexing. And the reserve dough 145 on the reservoir conveyor 110 would discharge directly into the portioning hopper 100. As noted, the change in speed enables an indexing whereby the weight of material on the slower operating horizontal or reservoir container is increased, such that the weight is sufficient to provide the reserve.

The exemplary embodiment of the invention is shown having a control system for a dough feeding and portioning system 1000. The controller is shown having as a programmable logic controller (PLC) 20. The PLC 20 communicates with one or more sensors 30, 40. As shown in the exemplary embodiment, these include, but are certainly not limited to, an at least one dough demand sensor 30 and an at least one staging sensor 40. A human machine interface (HMI) 10 is provided to allow for programming interface and control inputs to be entered by a user. These can include programming variables, such as but certainly not limited to types of dough/product, volume of product, speed of operation, and similar variables. An at least one output is also provided, in the exemplary embodiment these include but are not limited to operating signals, visual indicator signals, audio indicator signals and the like. These can show the operating status of the dough feeding and portioning system 1000 and/or its subsystems, such as the dough feeder 130 sub-system or the dough portioning sub-system.

This improvement of the operation is provided by the instant invention due in part to the newer generation of level or distance sensing sensors. In the past, in the available distance scanners the sensor would have to be set at the scanner and the set points would be a demand and demand stop setting where often the differential between the upper desirable limit (off) and the lower distance limit as to when to start would be a differential value that was input into the sensor and often was not settable. The only settable value was the lower limit in the hopper, which when reached would start the dough feed to fill the hopper and when the scanner would reach the set value or the settable differential was reached then the dough feed machine comprised of dough feeder and feed conveyors, would stop feeding. The instant invention provides a much more robust and varied setup.

In the instant invention a hopper demand or level sensor 30 is provided that determines the level of the dough in the hopper of the feeder machine accurately upon startup and continuously during operation. The hopper sensor 30 is shown in FIGS. 1 and 2, located above the hopper in FIGS. 1 and 2 and communicating with the controller in FIG. 3. One such example of these types of improved sensors that are used as for instance as the hopper level sensor 30 can include, as a non limiting example, a laser ranging sensor that sends a signal back to the Programmable Logic Controller PLC (20) measuring a distance read out from “eye to dough” level in the hopper. Using the hopper sensor reading that comes to the PLC, the signal is converted to a distance value and the HMI will allow for the programming of what is preferred to be both an upper limit (stop feeding) and the lower limit which would be where the PLC would take that value signal and get the feeder to start supplying or feeding more dough.

Additionally, when using the distance reading sensors like the dough hopper level sensor 30, there is an opportunity to program in multiple upper and lower set points to suit differing dough characteristics. Examples of where the level might vary can include, but are not limited to; a stiffer dough can need to be run at both a higher lower dough level limit as well as a higher upper level limit. Reason being a soft or sometime referred to as a soupy dough (more fluid) dough will flow and seal off the entry to the portioning machine so that no air can enter the portioning machine. Stiffer dough, which can include, but are not limited to stiffer and/or whole wheat products that are stiffer when fed into the hopper and/or which go in typically as strips, lumps, or clumps of dough that need to have more dough on top of the lower dough materials or segments so as to deform these dough materials in order to seal off passages in between dough clumps where air could pass thru and enter the portioning machine where portions of decreased weight would be the result. In the case of more fluid dough, greater weight is not needed to compress the air out, whereas in stiffer dough the additional weight from dough stacked slightly higher in the hopper aids in reducing air in the feed for the portioning machine.

This aspect of stopping before air enters the portioning machine in itself, in the case of food production machines, is often overlooked as the hopper sensors in previous devices could not be used to have multiple target levels programmed into them, but rather the settable on/off sensors were used. Compared to the on/off sensors in the prior art, the instant invention utilizes the real time level of the dough in the feed hopper for the portioner as set by the programmed level(s).

The hopper level demand sensor(s) 30 used in the instant invention will not only provide distance information or feedback but give the ability to program additional set points and or adjust the level height thresholds thru the HMI 10, which can be for instance, but is not limited to, a touch screen as shown. This allows for the system to accommodate the nature of the dough in the processing and portioning process in heretofore unheard of ways. The main point of having the portioning machine 90 shut down on a cut out dough level is to avoid the issues related to the introduction of air into the portioning machine. The instant invention not only resolves this during the dough refill cycle but improves avoidance of this problem during operations as well by expanding and accommodating larger numbers of dough types through the control system.

Again, it is important to understand that the introduction of air causes the portions to go under weight/size. These underweight portions must be removed and that is not always possible as the portioning machine 90 typically does not have a level sensor that can sense this “starvation” prior to the air being entrained. Also if the portioning machine 90 does have a sensor or feedback aspect on vacuum/air, the horse power and speed required to run the machine typically make the sensing of these changing values well beyond or after the fact so that air has already entered the portioning machine 90. So that even if the portioning machine 90 is monitoring it is typically still affected and when the air starts to enter the dough product portion, the portions affected must be removed. The point where it can be recognized can involve a lot of product that must be removed and that retrieval aspect can be hectic as it requires the portion removal from a product line that is running at a higher speed—which can be operating at four, six or eight hundred portions per minute. Additionally getting access to and removing all of the portions is typically not possible. Same issues occur with restarting the portioning machine 90 where the air must be purged from the dough product stream before portions are to the correct weight. Thus any improvements reducing or eliminating the entrainment of air in the portioning system will not only aid in keeping as close to near continuous operation of the portioning machine as possible but will also prevent further delays and effects from potentially avoidable air entrainment scenarios.

Another benefit provided by the new controller is its ability to provide at least two additional levels which can be programmed in which would provide for instance for a third longest distance from the overhead demand level sensor 30 to dough 140 level which can act as a warning distance that the dough 140 is at a level that is below the start to feed level 70, here an alarm low level 60 and an alarm either audible or visual or both would provide annunciation to indicate that the portioner 90 is approaching a dough 140 level where air can be soon be entering into the portioner 90. The fourth and lowest level or greatest distance from the sensor 30 to the very lowest dough level would be an emergency shutdown level 50 where the system is getting too close as measured by the sensor 30 and within its error rating to the point where the portioning machine 90 is in danger of entraining air into the portioner which should be avoided as if this were to occur then the indicated negative conditions as air entry into the portioning machine is incurred. At the auto stop operation sensor stop level 50 the portioning machine will be shut down before it entrains air and the portions start to go under sized, as noted herein throughout.

In addition, an alternative exemplary embodiment can use a timer which measures the time it takes for the conveyors to travel and can calculate volumetrically the supply such that if the demand level is reached and the signal for the dough feeder 130 to start is made and the dough level does not increase and or the sensor does not reach or sense a dough level of or approaching the start dough feed level that this could trigger a shut down level or mode as well, indicating an error in sensing or supply of the dough 140. As would be understood by one of ordinary skill in the art, a further way of accomplishing this would be to use additional individualized sensors for all or some of the levels to give the readings of dough level(s) desired individually and this would accomplish what has been indicated. It can be seen that anyone skilled in the art can make modifications to this device without imparting or departing from the novelty of the invention. It can also be seen that other such minor changes can be incorporated without departing from the intent of the invention.

The invention includes a method of operation for the portioning system. In the method of operation, the dough supply and portioning system 1000 operation is initiated. During normal operation, the feeder machine 130 provides dough to the portioner 90. An initial low level target value 70 is set in the PLC 20 and the level is measured by the dough hopper level sensor 30 in the dough portioner hopper 100 as it is filled. The PLC 20 works with the dough feeder 130 to reach and then maintain this level during normal operation. As the level is reached the portioner 90 begins to portion the dough 140.

For a period of time the portioner 90 is run whereby the dough is fed from the feeder to the conveyor system to the portioner hopper 100 to the portioner 90 and product is run out that can be underweight as measured at the output. This purges any entrapped air and ensures accuracy in the portioning. The dough portioner machine 90 will utilize dough 140 in the portioning machine hopper 100 and the level of dough 140 decreases. When the level of dough 140 decreases to or below the low set by the start value 70, the feeder 130 will be activated to provide dough 140 to increase the level of dough 140 in the portioning machine hopper 100. When the dough level reaches the stop or upper target level 80 the dough feeder 130 stops. Thus the instant invention brings dough 140 into the portioner hopper 90 to maintain the level between the stop or upper level or stop level 80 and the lower level or start level 70 as sensed by the fill sensor 30.

In the event that the portioning machine 90 is running and dough 140 is not being introduced to the portioning machine hopper 100 then the level of dough 140 will start or continue to go down and it can go down to reach or go below the alarm low level 60 where the portioning machine demand level sensor 30 detects or provides a signal to the PLC 20 and or the HMI 10 which will cause or enable a low level alarm buzzer 150 and light 160 to come on to alert operators of a low level condition to provide a signal that dough 140 level is decreasing below an acceptable level but portioner is still running. This can be because of an outside error or it could indicate that the dough feeder 130 needs to replenish the dough 140 by receiving it from the mixer 200. The process is a dough refill cycle, whereby the dough feeder 130 is resupplied by one of several mechanisms depending on the location and nature of the mixer 200 and the line. In either case, the instant invention utilizes a measured reserve in a reservoir, in the exemplary embodiment shown this is a reservoir conveyor 110 system.

The dough reservoir conveyor 110 is specifically designed so that it would be wider, longer or of sufficient capacity to hold a quantity of dough in excess of what is needed to be on hand and supply the dough portioning machine(s) 90 during a dough feeder refill cycle. The content or amount of dough would be in excess of what is needed for the maximum reasonable amount of time, as measure by one or more sensors and/or timing sequences initiated by the one or more sensors in the several machine subsystems, so as to carry out the time interval of travelling the dough feeder 130 from the dough discharge docking station to the mixer, receiving dough from the mixer, then returning the dough feeder to the dough discharge docking station where it indexes into the correct position and then resumes dough feed to conveyors and an allowable amount of additional time. This amount can be set in the PLC 20 controller via the HMI 10 in a manner similar to the level settings 50, 60, 70, 80 and programmed to meet the type and time taken to refill the feeder from the mixer. As noted above, the refill cycle includes releasing and reestablishing a variety of safety mechanisms, releasing the dough 140 from the mixer 200 into the feeder 130 or its components, and returning the safety mechanisms and the components to a secure position to resupply the feeder 130.

Upon return of the dough feeder hopper to the discharge station, the feeder 130 discharges per normal operations dough/material 140 into the vertical conveyor and then upon the overhead reservoir conveyor 110 at the slower feed speed till such a time as that when reserve capacity dough on the conveyors is used in part or entirely up where there would be a sizable open or void area on the reserve conveyor which would be sensed in that the feed is running but the dough 140 level in the feeder hopper 100 would not be rising or being replenished at which point the PLC would presume that there is a void on the reserve conveyor 140 which was caused by the feeder re-fill procedure. At this time the overhead conveyor 110 would go to full speed so as to remove the void area of the conveyor and get dough/material to the portioning machine hopper as quickly as possible.

A sequencing system is provided such that the reservoir conveyor 110 and the PLC 20 communicate and the dough can rapidly get conveyed to portioning machine by going in high speed when the feeder machine reconnects the portioning machine 90 on line. Then when the feed system running at high speed has once again brought sufficient dough 140 to the portioning machine hopper 100 so that the target level 70 is satisfied or has reached the upper operating limit height 80, the feeder is either slowed or shut off. High conveyor speeds would remain for an additional period of operation or the delivery of sufficient volume of dough to the portioner at which point the reservoir conveyor 110 speed would be decreased to a value of preferably between about ninety and twenty percent of its speed, but most preferably about fifty percent of its operating speed. And with the overhead reserve and the reservoir conveyor 110 running at lower speed than that conveyor filling the reservoir conveyor conveyor so as to get a higher amount of dough material per unit length of the reservoir conveyor 110 as needed. After running for a set period of time with the reservoir conveyor traveling at the reduced rate of speed then the PLC would send a signal to the overhead conveyor drive controller which would slow this reserve conveyor 110 to a speed of 50 to 20 percent of normal full speed so as to get the maximum weight per unit of belt length and provide the desired reserve capacity.

This will slow the delivery of dough that is on the dough conveyor 110 but in the same manner it will mean that the dough 140 that is now depositing on the dough conveyor 110 will be deposited at the same feed rate while the receiving or horizontal or reserve or reservoir conveyor 110 is going slower or that the dough 140 mass per unit of length of conveyor length is double, triple, or greater what it would be if or when the dough conveyor travels at full speed. In a non-limiting example, typical high speed delivery rates would be at a load rate of about five pounds of dough per foot of reserve conveyor 110 to up to a dough deposit load rate of about twenty pounds per linear foot of conveyor 110. And when you have a conveyor of twenty feet in length then it can be understood that the reservoir capacity of the conveyor 110 will be about twenty feet times twenty pounds per foot of conveyor 110 belt for a total of about four hundred pounds of reserve dough 140 which is more than typically required to operate for five minutes while the feeder 130 goes to and returns with a full load of fresh bulk dough 140 from the mixer 200. And the reserve dough 140 on the conveyor 110 would discharge directly into the portioning hopper 100. In the unlikely event that the refill cycle is not being called or if there is a full amount of dough in the feeder but a sensing or other error has occurred, at this point the operator may need to stop the portioning machine 90 and prevent entrainment of air as discussed herein throughout.

Alternatively, if no errors have occurred and no additional dough 140 is being provide, then production and dough feeding will continue till the dough in the feeder hopper is exhausted where it will typically either be an end of production or change in product/dough type. At that point there will be possible cleaning of the mixer carried out and or start of a similar but new type of dough and a break is put in between doughs. In either case dough 140 is run out as far and as much as possible from the feeder and then it can be that the dough will be run out as far as possible from the portioning machine.

In the case where it is desired to run out as much dough 140 as possible from the feeder 130 then a bypass switch will be used to bypass the hopper level sensor 30 and keep the portioning machine 90 running out as much dough 140 as possible. Where and when machines are run out as much as possible, at this point if a similar dough is to be utilized then the new type of dough can be discharged from the mixer 200 and then run thru and into the portioning machine 90 before restarting. If it is to be where a changeover is to be carried out then a silence/override button (not shown as may not be desired by customer and or may just be an option and is not a part of the novelty of this invention) can be activated whereby the alarm is deactivated and the machine will continue to run out of dough 140 as much as possible to lessen the work needed to clean out the portioning machine 90.

In the event that a full cleaning is required as with going from dough containing an allergen then machines are disassembled and washed out to remove all allergens. Machines are then re-assembled, next type of dough is discharged from mixer 200 to dough feeder 130 and dough 140 is filled into portioning machine and line is re-started.

In the event that it is not a point whereby the dough 140 needs to be cleared out it could be, but is certainly not limited to, a feed issue or where an operator has taken too long to obtain dough 140 from the mixer 200 and therefore the system could be starving out of dough 140. If it is not the case of a change over and the level of dough in the portioning machine hopper is reaching a critical level, then if this dough level reaches and or goes below the stop operation level 50 then the portioning machine 130 will stop operation. This stop set point is typically set so as to stop the portioning machine 90 before the dough 140 in the portioning machine hopper 100 does not go so low that air is drawn into the portioning machine 90 which creates the issue whereby the portions being created go underweight and must be removed from the line and typically it is a frantic procedure with significant dough 14 portions going on the floor so as to get most of the product of questionable weight out of the line and then one must clean up the dough on the floor which is where most gets thrown so as to complete the task in the time that is available.

Upon restarting, when air is in the portioning machine 90 the portioner requires purging of dough 140 thru the portioning machine 90 to clear out the air and during this purging again the dough 140 must be pulled from the line and checked as to when portion weights become correct and stabile/consistent so that product of proper size and weight can be produced as discussed herein above. Again it is taxing on time and materials.

A far better system is that when the demand sensor 30 senses reaching a critically low level 50, the demand sensor 30 signals the PLC 20 and stops the portioning machine or portioner 90 just before air were to enter into the portioning machine 90 and auto stop to stop operations. When one stops the portioning machine 90 at that point or time then one can restart the portioning machine 90 and have portions of correct size and weight within two to four portions coming out of the portioning machine 90.

Thus, in the larger picture, the operation of the instant invention as part of a baking production line aids in consistent manufacture and cost savings. If product fails to go into an oven, for example, for a significant period of time on the line then a gap of product to be baked occurs. The ovens continue to heat and this heat energy is added to the oven, but if there is an absence of materials that will absorb that heat in a localized area due to the missing product a hotspot occurs. If the localized area is small in relationship to the size of the oven then negative results such as the baked softness of product and color can not be significantly changed but in the case where the localized area of the oven is large as say on the order of fifty percent, one can virtually guarantee degradation of product. By using the control system of the instant invention to minimize the time the line is stopped it can reduce this time period by several minutes and remove it in an ideal case. Even by reducing the stoppage of product, where a several minute improvement represents an improvement of the absence of product, where the additional heat is input, for say only about 20% of the oven capacity, this would still represent a much reduced negative effect on the baking of the product. Thus, this decrease translates not only into a reduction in lost time and/or production losses, it also reduces waste due to burning of product as a result of being subject to localized higher temperatures, as well as improved controlled stoppages when needed and removal of product, and the like as ancillary benefits translating to overall cost savings.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. can be present without falling outside the scope of the corresponding claim or recitation. As used herein, when the phrase “at least” is used as the transition term in, for example, a preamble of a claim, it is open-ended in the same manner as the term “comprising” and “including” are open ended.

To the extent that process are indicated, the relative order and execution to the process is non-limiting in its explanation as an example and additional steps or process can be included in the overall process without departing from the spirit of the invention whilst reading on to the steps enumerated in the claims of the invention, as would be understood by one of ordinary skill in the art of the invention.

The embodiments and examples discussed herein are non-limiting examples. The invention is described in detail with respect to preferred embodiments, and it will now be apparent from the foregoing to those skilled in the art that changes, and modifications can be made without departing from the invention in its broader aspects, and the invention, therefore, as defined in the claims is intended to cover all such changes and modifications as fall within the true spirit of the invention.

What is claimed is:

1. A dough portioning machine with a feeding device having a dough run time controller and sensor system as components in a commercial baking system, comprising:
a portioner;
a dough feeder machine providing dough to the portioner;
a controller;
a hopper coupled to the portioning machine and receiving dough from the dough feeder machine; and
a hopper demand or level sensor that determines the level of the dough in the hopper of the feeder machine, wherein the dough portioner machine utilizes dough in the portioning machine hopper, as the level of dough decreases or below a low setting relative to a start value, the controller senses through the hopper demand or level sensor the low setting and the feeder is activated to provide dough to increase the level of dough in the portioning machine hopper, when and until the dough level reaches a stop or upper target level in the hopper whereby the dough feeder machine stops.

2. The dough portioning machine with a feeding device of claim 1, wherein the dough feeder has a refill cycle, by which the feeder machine moves during the refill cycle to receive additional dough from a mixer and returns to a feeding position.

3. The dough portioning machine with a feeding device of claim 2, further comprising an at least one dough reservoir conveyor adapted to hold a quantity of dough in excess of what is consumed by the portioner during the refill cycle.

4. The dough portioning machine with a feeding device of claim 1, further comprising an at least one conveyor feeding the hopper.

5. The dough portioning machine with a feeding device of claim 4, wherein the at least one conveyor includes an at least one vertical conveyor conveying dough to an at least one dough reservoir conveyor, the reservoir conveyor having a dough reserve thereon.

6. The dough portioning machine with a feeding device of claim 4, wherein the at least one vertical conveyor conveying dough to an at least one dough reservoir conveyor which is coupled to the hopper with an amount of dough on the at least one dough reservoir conveyor representing a reserve of dough.

7. The dough portioning machine with a feeding device of claim 6, further comprising a dough discharge docking station for the at least one feeder, wherein the refill cycle further includes the interval of time for the feeder to decouple from the docking station travel from the dough discharge docking station to the mixer, receive dough from the mixer, then return the dough feeder to the dough discharge docking station where it indexes into a feeding position.

8. The dough portioning machine with a feeding device of claim 7, further comprising at least one safety mechanism on the at least one feeder or the dough discharge docking station, wherein the refill cycle further includes the time to release and reestablish the at least one safety mechanism and securing.

9. The dough portioning machine with a feeding device of claim 5, further comprising additional sensors coupled to the controller, wherein the controller is adapted to use the one or more additional sensors to calculate timing sequences initiated to replenish the dough reserve on the at least one dough reserve conveyor after a refill cycle.

10. The dough portioning machine with a feeding device of claim 9, wherein the controller varies the speed of the at least one dough reservoir conveyor.

11. The dough portioning machine with a feeding device of claim 5, wherein the controller is adapted to receive commands through the HMI to provides for programmable adjustments to the system.

12. The dough portioning machine with a feeding device of claim 5, wherein the controller is adapted to operate the portioner, the feeder machine providing dough to the portioner, the hopper and the at least one dough reservoir conveyor, such that the feeder discharges dough onto the at least one vertical conveyor and then upon the at least one reservoir conveyor at the slower feed speed till such a time that the reserve capacity dough on the reserve conveyor is used in part or entirely up where there would be a sizable open or void area on the reserve conveyor, which is sensed in that the feed is running but the dough level in the hopper would not be rising or being replenished at which point the controller presumes that there is a void on the reserve conveyor which was caused by refill cycle.

13. The dough portioning machine with a feeding device of claim 12, wherein the controller is further adapted when sensing the void to operate the conveyor at higher speed so as to supply dough to the portioning machine hopper and cause it to rise toward the stop level and refill the at least one dough reservoir conveyor.

14. The dough portioning machine with a feeding device of claim 12, further comprising a sequencing subsystem, wherein the sequencing subsystem communicates with the controller and is configured such that it governs the volume of the dough remaining on the reservoir conveyor so that it can be calculated and communicated with the controller and the dough is more rapidly conveyed to portioning machine by going into a higher speed of operation when the feeder machine reconnects to the docking station.

15. The dough portioning machine with a feeding device of claim 14, wherein when the at least one vertical conveyor and the at least one dough reservoir conveyor running at the higher speed has deposited sufficient dough on the reservoir conveyor and brought sufficient dough to the portioning machine hopper so that the high target level is sensed.

16. A method of operating a dough portioning machine, comprising:
supplying a feeder with dough;
conveying the dough from the feeder to a hopper attached to a portioner, with an at least one conveyor, with a volume of dough held as a reserve on the conveyor;
depositing dough into the hopper and sensing a level in the hopper with an at least one sensor;
operating the dough portioning machine such that the feeder is moved to refill with dough during a refill cycle while continuing to supply the hopper from the reserve of dough on the at least one conveyor, wherein the amount of dough in reserve on the at least one conveyor is calculated by a controller.

17. The method of operating a dough portioning machine of claim 16, wherein the step of operating the dough portioning machine further comprises operating an at least one vertical conveying dough to an at least one reservoir conveyor which maintains the reserve of dough thereon.

18. The method of operating a dough portioning machine of claim 17, wherein the step of operating the at least one vertical conveying and conveying dough to a reservoir conveyor further comprises controlling with the controller the speeds of the at least one vertical conveyor and the at least one reservoir conveyor such that the reserve of dough is maintained.

19. The method of operating a dough portioning machine of claim 17, wherein controlling of the speeds of the at least one vertical conveyor and the at least one reservoir conveyor further comprises running the at least one reservoir conveyor at a lower speed than the at least one vertical conveyor filling the at least one reservoir conveyor so as to raise a material per unit length of dough on the reservoir conveyor.

20. The method of operating a dough portioning machine of claim 16, wherein controlling of the speeds of the at least one vertical conveyor and the at least one reservoir conveyor further comprises controlling the speed of the at least one vertical conveyor relative to the at least one reservoir conveyor such that the reservoir conveyor accumulates a volume of dough for the reserve while the volume of dough in the hopper is less than a high limit as sensed by the at least one sensor.
